(19) United States
(12) Patent Application Publication
(10) Pub. No.: US 2008/0082910 A1
(43) Pub. Date: Apr. 3, 2008

(54) Text data generation program, text data generation device, text data generation method, text-processing tool program, text-processing tool device; and text processing method

(75) Inventors: Fumihito Nishino, Kawasaki (JP); Terunobu Kume, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/894,219

(22) Filed: Aug. 20, 2007

(30) Foreign Application Priority Data
Oct. 3, 2006 (JP) 2006-272033

(51) Int. Cl. G06F 3/14

(52) U.S. Cl. 715/231

(57) ABSTRACT

A text data generation program generates text data as a target of a text processing tool. The program controls a computer to receive location information of web page data from the text-processing tool, acquires web page data from a web server via a communication device in response to the location information, acquires annotation data, which is linked with the web page data, from an annotation server via the communication device, converts contents of the acquired annotation into a form that can be interpreted by the text-processing tool, embeds the converted contents at a position to which the annotation should link, and outputs the web page data to which the contents of the annotation are embedded to the text-processing tool.

### BACKGROUND OF THE INVENTION

The present invention relates to a program, a device, and a method for generating text data as a processing target of a tool such as a machine translation system, a text-to-speech (TTS) system, an automatic text summarization system, an automatic kanji-kana conversion system, and a named entity extraction tool (referred to as a “text-processing tool” in the specification). Further, the present invention relates to a program, a device, and a method for implementing such a text-processing tool.

As everyone knows, when a processing target text contains vocabularies that are not registered in a translation dictionary or idioms of Chinese characters that have special readings, the text-processing tool can output neither a translation nor synthesized voice appropriately about the vocabularies or the idioms. Therefore, some text-processing tools interpret the information about a translation and a pronunciation that is embedded into the text as tags to reflect them to the output, for example. A user can improve output precision by editing a text so as to embed such information in advance. A text-processing tool that can appropriately process a text in a web page exhibited through the Internet is developed in recent years. Some text-processing tools handle markup text. Some text-processing tools handle non-markup text after removing markup.

For example, this kind of technique is disclosed in Japanese patent publication 3771831, Japanese unexamined patent publication 2004-046745 (JP2004-046745A), and Japanese unexamined patent publication 2006-127117 (JP2006-127117A).

However, even if a user wants to edit a text to improve output precision in advance, since the original of the web page data is saved at the web server side, there is a problem that a user other than the creator of the web page cannot edit the source text. Of course, although a user can edit the web page data when it is copied in advance, there is a problem concerning the Copyright Law. Further, if the problem concerning the Copyright Law can be solved, the text data that is created by a pre-editing based on the copied data can be kept to make the data commonly accessible to users in order to prevent a conflict among pre-editing by users. However, in such a case, since an update of the web page is not reflected to the text data, there is a problem to output earlier information.

### SUMMARY OF THE INVENTION

The present invention is developed in view of the above-mentioned problems in the prior art. An object of the present invention is to enable a pre-editing of a text on a web page in order to improve output precision and is to reflect an update of the web page to an output of the text processing.

In order to achieve the above-mentioned object, a computer readable medium according to the present invention stores a text data generation program, which generates text data as a target of a text processing tool, and controls a computer to execute functions including:

a reception function for receiving location information of web page data from the text-processing tool;

a web page data acquisition function for acquiring web page data from a web server via a communication device in response to the location information that is received by the reception function;

an annotation data acquisition function for acquiring annotation data, which is linked with the web page data acquired by the web page data acquisition function, from an annotation server via the communication device;

a reflection function for converting contents of the annotation acquired by the annotation data acquisition function into a form that can be interpreted by the text-processing tool and for embedding the converted contents at a position to which the annotation should link; and

an output function for outputting the web page data to which the contents of the annotation are embedded by the reflection function to the text-processing tool.

An annotation in a book is information about an interpretation of a phrase in a main body or information about a reference document that is described in a page corner or in a chapter end. On the other hand, an annotation in web page data is attendant information that is linked to a part (a character string, an image) in a web page without reference to a source text by a technique such as XLink (XML Linking Language). That is, a user at the web client side can also link attendant information to a part of a web page by means of the annotation technique. The information about contents of the annotation and the link position information are managed by the annotation server under the condition where the information is linked to the location information of the web page.

According to the text data generation program of the present invention mentioned above, a computer embeds the contents of the annotation data linked with the web page data into the web page data, and then, delivers the web page data to the text-processing tool.

At the time, if the contents of the annotation data are the information for improving the output precision of the text-processing tool, the text-processing tool interprets the information and reflects it to the output. That is, since the information for improving the output precision of the text-processing tool is linked to the web page as an annotation, a user can edit the web page data in advance. Since an annotation is unaffected by an update of the web page except an update of the portion to which the annotation is linked, when the web page is updated, the update is reflected to the output of the text-processing tool.

In order to achieve the above-mentioned object, a text-processing tool program according to the present invention controls a computer to execute functions including:

a web page data acquisition function for acquiring, when location information of a web page data is designated, the web page data from a web server via a communication device in response to the location information;

an annotation data acquisition function for acquiring annotation data, which is linked with the web page data acquired by the web page data acquisition function, from an annotation server via the communication device;

a reflection function for embedding contents of the annotation acquired by the annotation data acquisition function in a predetermined form at a position to which the annotation should link; and

a text-processing function for executing a text-processing based on the web page data into which the contents of the annotation are embedded by the reflection function.

Therefore, according to the text-processing tool program, a computer generates text data by the functions equivalent to the functions of the above-mentioned text data generation program of the present invention, and processes the generated text.

As described above, according to the present invention, a user can edit a text in advance for improving output precision even if a text on a web page is processed. Further, when the web page is updated, the update is reflected to the output of the text-processing.

### DESCRIPTION OF THE ACCOMPANYING DRAWINGS

FIG. 1 shows a system configuration of a computer network system of an embodiment,

FIG. 2 is a flowchart showing a preparation process of the embodiment,

FIG. 3 is a flowchart showing an annotation inspection subroutine of the embodiment,

FIG. 4 shows an example of text processing by the preparation process of the embodiment, and

FIG. 5 shows another example of text processing by the preparation process of the embodiment.

### DESCRIPTION OF THE PREFERRED EMBODIMENTS

Hereafter, an embodiment of the present invention will be described with reference to the accompanying drawings.

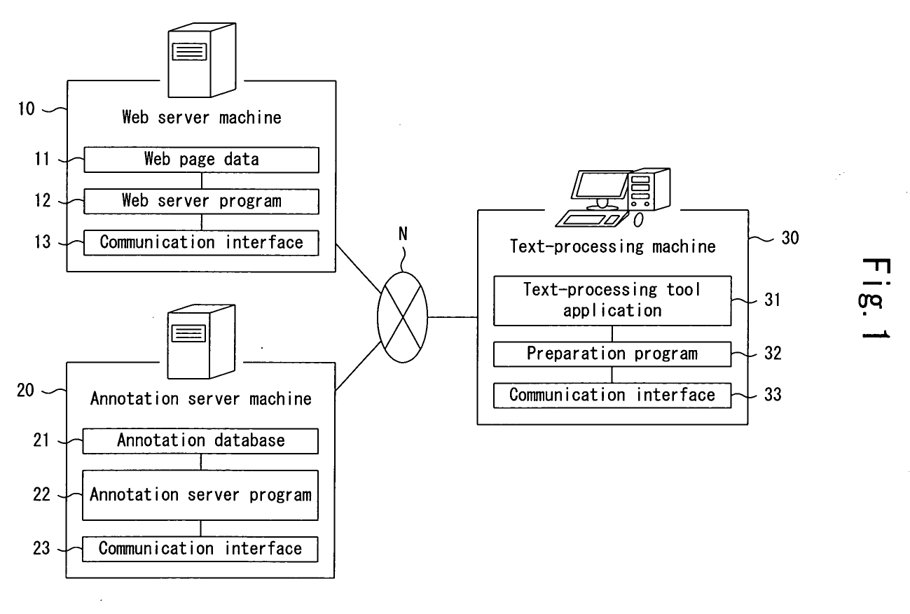

FIG. 1 shows the system configuration of the computer network system of the embodiment.

The computer network system of the embodiment consists of a web server machine 10, an annotation server machine 20, and a text-processing machine 30. The machines 10, 20, and 30 are connected via a network N so that they can communicate mutually.

The web server machine 10 is a general purpose computer to which a function as a web server is added. Therefore, the web server machine 10 contains at least a hard disk, a CPU, a DRAM, and a communication adapter that are not illustrated. The hard disk is a nonvolatile storage device that stores various kinds of programs and data. The CPU is a processing unit that processes according to a program in the storage. The DRAM is a volatile storage device to which a program is cashed and workspace is developed when the CPU processes. The communication adapter is a communication device that exchanges data with other computers on the network N.

The storage of the web server machine 10 stores web page data 11, a web server program 12, and a communication interface program 13. The web page data 11 is HTML (Hypertext Markup Language) data that is provided to other computers through the network N. A unique URL (Uniform Resource Locator) is assigned to each the web page data 11 as location information. Receiving an HTTP (Hypertext Transfer Protocol) request message with specification of URL from a web client machine (not shown), the web server program 12 sends an HTTP response message containing web page data 11 of the web page defined by the URL. The communication interface program 13 is a protocol stack (program) for exchanging the data with other computers through the network N according to TCP/IP (Transmission Control Protocol/Internet Protocol).

The annotation server machine 20 is a general purpose computer to which a function of the annotation server is added. Therefore, the annotation server machine 20 contains at least a hard disk, a CPU, a DRAM, and a communication adapter that are not illustrated.

The hard disk of the annotation server machine 20 stores an annotation database 21, an annotation server program 22, and a communication interface program 23. Here, an annotation is attendant information that is linked to a part (a character string, an image) in a web page without reference to a source text by a technique such as XLink (XML Linking Language). The annotation database 21 stores information about the linked position of the annotation and information about contents and a creator or the like that are linked to the location information (URL) of the web page so that the information can be freely searched. The linked position included in the annotation data may be information that specifies routes and nodes of each of blocks related in a tree structure in a source text, like the information described according to Xpath (XML Path Language), for example. Alternatively, the information of the linked position may be a block ID (Identification) that is uniquely assigned to each block. Anyway, the annotation data uses the abstract information that logically specifies the position of an object (character string) to which the annotation is linked as position information.

The annotation server program 22 is used to register an annotation and to distribute annotation data. Specifically, when the annotation server program 22 receives a URL and information about the linked position of the annotation in the web page shown by the URL, the contents of the annotation, or information about a creator from an annotation editor that is introduced into a web client machine (not shown) as an expanded function of a web browser, the program 22 registers the information about the annotation with linking to the received URL into the annotation database 21 as annotation data.

Further, when the annotation server program 22 receives an inquiry with the URL from the web browser of the web client machine which is not illustrated with URL, it investigates whether the URL is registered into annotation database 21, and answers. The annotation data will be transmitted, if it is required from the web browser when the URL is registered. The communication interface program 23 is a TCP/IP stack as in the case of the web server machine 10. The text-processing machine 30 is a personal computer to which text-processing functions such as a machine translation system, a text-to-speech system, an automatic text summarization system, an automatic kanji-kana conversion system, and a named entity extraction tool are added. Therefore, the text-processing machine 30 consists of a display such as a liquid crystal display, input devices such as a keyboard and a mouse, and a main body to which these devices are connected. The main body contains a hard disk, a CPU and a DRAM, and the communication adapter.

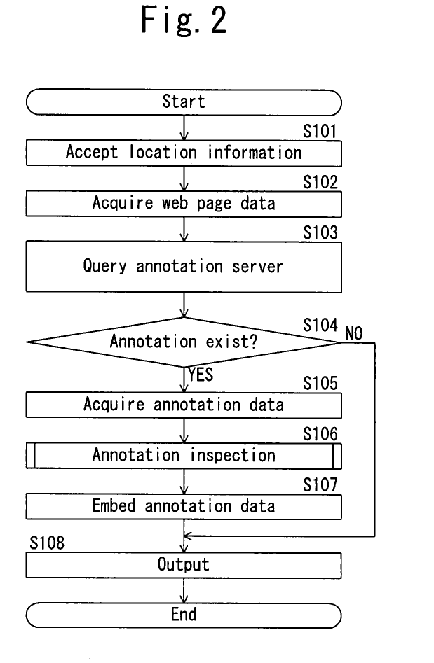

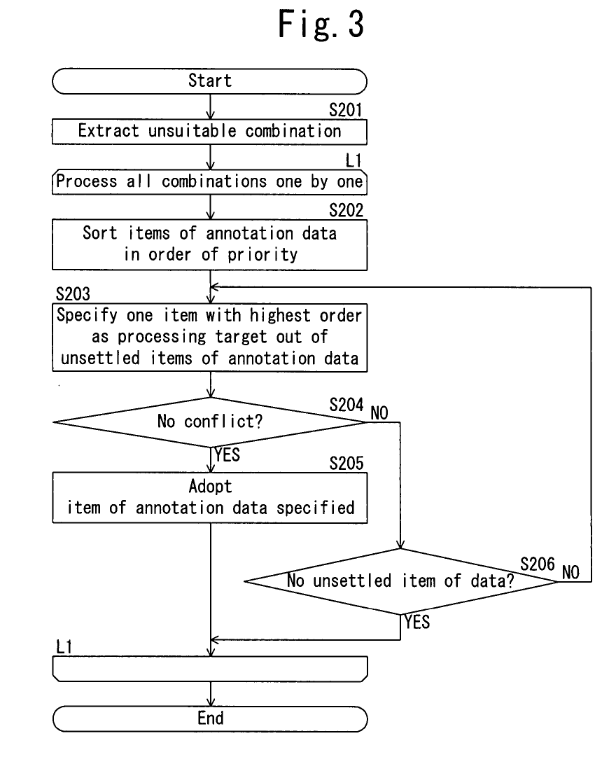

The hard disk of the text-processing machine 30 stores a text-processing tool application 31, a preparation program (a text data generation program) 32, and a communication interface program 33. The text-processing tool application 31 is used for outputting a translation, a synthesized voice, or the like by executing a certain process based on the text data. When a text on a web page is chosen by the text-processing tool application 31 as a processing target, the preparation program 32 is used for embedding an annotation data into the web page data of the web page concerned. The preparation program 32 uses an HTTP client module. The HTTP client module may be included in a web browser (not shown), and may be prepared separately. The process of the preparation program 32 is generated by the demand from the text-processing tool application 31, and is extinguished by returning text data to the text-processing tool application 31 as a processing result. The concrete contents of the process concerning this process (it is referred to as a preparation process 32) will be described below with reference to FIG. 2 and FIG. 3. The communication interface program 33 is a TCP/IP stack as in the case of the web server machine 10.

FIG. 2 is a flowchart showing the contents of the preparation process 32.

In the first step S101, the preparation process 32 accepts the location information (URL) delivered from the text-processing tool application 31. The CPU (not shown) that executes the process in step S101 corresponds to the accepting function mentioned above.

In the next step S102, the preparation process 32 acquires web page data from the web server (a function generated by a CPU that executes a program) 12 based on the location information. The CPU (not shown) that executes the process in step S102 corresponds to the web page data acquisition function mentioned above.

In the next step S103, the preparation process 32 queries the annotation server (a function generated by a CPU that executes a program) 22 to detect the presence or absence of the annotation data corresponding to the location information concerned.

In the next step S104, the preparation process 32 determines whether the response from the annotation server 22 shows that the annotation data exists or not. When the response shows that the annotation data exist, the preparation process 32 advances the process to step S105.

At step S105, the preparation process 32 acquires all items of the annotation data that contains the location information (URL) concerned from the annotation server 22. The CPU (not shown) that executes the process in step S105 corresponds to the annotation data acquisition function mentioned above.

In the next step S106, the preparation process 32 executes an annotation inspection subroutine.

FIG. 3 is a flowchart showing the contents of the annotation inspection subroutine.

In the first step S201 of the annotation inspection subroutine, the preparation process 32 extracts unsuitable combinations out of the acquired annotation data. Specifically, the preparation process 32 extracts all the combinations of the annotation data in which character strings of linked destinations of the annotations on the web page are overlapped in part or as a whole, based on the location information that is acquired in step S105.

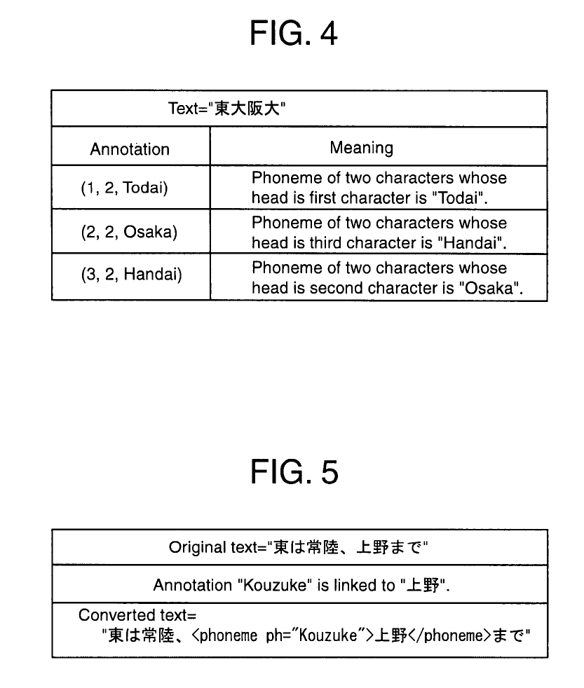

As shown in FIG. 4, when there are three annotations for the character string containing four Chinese characters, the range of character string to which the first annotation (0, 2, Todai) is linked and the range of character string to which the third annotation (1, 2, Osaka) is linked are overlapped in part, and the range of character string to which the second annotation (2, 2, Handai) is linked and the range of character string to which the third annotation (1, 2, Osaka) is linked are overlapped in part. In this example, three items of the annotation data are extracted as one combination.

There are other conditions that extract the unsuitable combinations. The condition can be established by a user in advance.

In the first process loop L1, the preparation process 32 executes steps S202 through S206 one by one for each of all the extracted combinations.

In step S202, the preparation process 32 sorts the items of the annotation data into the predetermined order within the combinations of the processing targets. For example, the items of the annotation data are sorted by an order of creation date of annotation, or an order of point that shows on-the-job status of a creator. There are other conditions for sorting. The condition can be established by a user in advance.

In the next step S203, the preparation process 32 specifies one item of the annotation data with the highest order as a processing target out of the unsettled items of the annotation data.

In the next step S204, the preparation process 32 determines whether the item of the annotation data specified as the processing target conflicts with the items of the annotation data that have been adopted in advance. Specifically, the preparation process 32 determines whether the linking range of the annotation defined by the item of the annotation data specified as the processing target overlaps perfectly or partially with the linking range of the annotations defined by the items of the annotation data that have been adopted in advance. When the item of the annotation data as the processing target does not conflict with the items of the annotation data that have been adopted in advance, the preparation process 32 advances the process to step S205.

In step S205, the preparation process 32 adopts the item of the annotation data specified as the processing target. Then, the preparation process 32 advances the process to step S206.

On the other hand, when the item of the annotation data specified as the processing target conflicts with the items of the annotation data that have been adopted in advance in step S204, the preparation process 32 branches the process from step S204 to step S206.

In step S206, the preparation process 32 determines whether an unsettled item of the annotation data exists in the combinations of the processing targets. When an unsettled item of the annotation data exists in the combinations of the processing targets, the preparation process 32 branches the process from step S206 and returns the process to step S203.

On the other hand, when an unsettled annotation data does not exist in the combinations of the processing targets, the preparation process 32 finishes a series of the processes concerning the first process loop L1. Finishing the first process loop L1, the preparation process 32 can display a screen that shows a conflict of the linking ranges of the items of the annotation data to notify a user as such. Alternatively, the preparation process 32 can list the contents of the respective annotations as choices and adopt the annotation that is chosen by a user.

Choosing the items of the annotation data whose linking ranges of the annotations are not overlapped from each of all the extracted combinations in the above-mentioned first process loop LI, the preparation process 32 finishes the annotation inspection subroutine shown in FIG. 3 and advances the process to step S107 in FIG. 2.

An item of the annotation data that has not been extracted in step S201 is used in the next step S107 as an item of the annotation data that passes the inspection as well as the item of the annotation data adopted in step S205.

In step S107, the preparation process 32 embeds the information based on the item of the annotation data to web page data for each of the items of the annotation data that pass the inspection.

When embedding the contents of the item of the annotation data to the web page data, the preparation process 32 converts the contents into the form that can be interpreted by the text-processing tool 31, and embeds the converted contents into the web page data at the position that is defined by the position information included in the item of the annotation data. For example, as shown in FIG. 5, when the original text is inputted and the annotation is linked, the original text is converted into the converted text. Embedding the contents of all the items of the annotation data that pass the inspection into the web page data, the preparation process 32 advances the process to step S108. The CPU (not shown) that executes step S108 corresponds to the reflection function mentioned above.

On the other hand, when the response from the annotation server 22 shows that there is not item of the annotation data in step S104, the preparation process 32 branches the process from step S104 to step S108.

In step S108, the preparation process 32 outputs the web page data to the text-processing tool 31. The outputted web page data includes the annotation that is embedded in step S107 or it is acquired in step S102.

Then, the preparation process 32 finishes the process concerning FIG. 2, and is extinguished.

According to the preparation program 32, the computer inserts the contents of the items of the annotation data related to the web page data into the web page data, and then, delivers it to the text-processing tool.

At this moment, if the contents of the annotation are embedded into the web page data as a form of tag information as shown in FIG. 5, the text-processing tool 31 interprets the tag information to reflect it to the output of a translation or a synthesized voice.

That is, a user can perform the pre-editing for increasing the output precision of the text-processing tool 31 by linking an annotation to the corresponding position in a web page. The annotation is a translation or a pronunciation with respect to a vocabulary that is not registered in the translation dictionary or an idiom of Chinese characters that has a special reading.

Since the information about the linking position of the annotation is logical, the information is not affected by an update of the web page except for an update of the part linked by the annotation. Therefore, even if the web page is updated, the update is reflected to the output of the text-processing tool.

Further, the annotations can be established by a plurality of users in their own ways. In this case, a plurality of annotations may be linked to the same character string, and the ranges of a character string linked by the annotations may be overlapped partially or perfectly.

However, according to the embodiment, when a plurality of annotations are linked to the same range, one of them is chosen according to predetermined conditions (steps S201-S206). Therefore, a plurality of annotations linked to the same range are not outputted simultaneously.

### Modified Embodiment

The preparation program 32 converts the web page data and the annotation data into the form that can be processed by the text-processing tool 31 in the above-described embodiment. However, the data can be converted by a subject other than the preparation program 32.

For example, the text-processing tool 31 can execute the process for acquiring web page data (corresponding to step S102), the process for inspecting the annotation (corresponding to step S106), and the process for embedding the annotation (corresponding to step S107).

In the latter case, the preparation program 32 performs only the process (corresponding to steps S103 through S105 in FIG. 2) for acquiring the item of the annotation data from the annotation data server 22 when it receives a request from the text-processing tool 31.

In this modified embodiment, the text-processing tool 31 may classify a web page text into some units according to paragraph or section, for example, and may advance the process in order by the unit. In this case, whenever the text-processing tool 31 processes one unit, it inquires about presence or absence of an annotation linked by the unit. When the annotation exists, the text-processing tool 31 execute the inspection of annotation (corresponding to step S106) and the embedding of the annotation (corresponding to step S107) for the unit.

In the above-described embodiment and the modified embodiment, it is described that the text-processing tool 31 directly performs the text processing with respect to the web page data to output a translation and a synthesized voice. However, there are other methods to perform the text processing. For example, the text-processing tool 31 can be designed to execute the text processing about a plain text only. In this case, the preparation program 32 must create text data of the plain text that is acquired by removing tag information that is necessary for a hyper-text display after step S107 and before step S108.

What is claimed is:

1. A computer readable medium storing a text data generation program for generating text data as a processing target of a text-processing tool, said program controlling a computer to execute functions comprising:
a reception function for receiving location information of web page data from the text-processing tool;
a web page data acquisition function for acquiring web page data from a web server via a communication device in response to the location information that is received by said reception function;
an annotation data acquisition function for acquiring annotation data, which is linked with the web page data acquired by said web page data acquisition function, from an annotation server via said communication device;
a reflection function for converting contents of the annotation acquired by said annotation data acquisition function into a form that can be interpreted by said text-processing tool and for embedding the converted contents at a position to which the annotation should link; and
an output function for outputting the web page data to which the contents of the annotation are embedded by said reflection function to said text-processing tool.

2. The computer readable medium according to claim 1, wherein said reflection function executes the converting and the embedding only for annotation data that satisfy a predetermined condition among the annotation data acquired by said annotation data acquisition function.

3. The computer readable medium according to claim 2, wherein said reflection function chooses, when there are combinations of the annotation data in which character strings of linked destinations of the annotations on the web page are overlapped in part or as a whole among the annotation data acquired by said annotation data acquisition function,
the annotation data from the combinations by determining the annotation data whose range of the linked destination does not overlap with that of the other annotations, and wherein
said reflection function converts and embeds the contents of the annotation only for the chosen annotation data.

4. A text data generation device that generates text data as a processing target of a text-processing tool, said device comprising:
a reception section for receiving location information of web page data from the text-processing tool;
a web page data acquisition section for acquiring web page data from a web server via a communication device in response to the location information that is received by said reception section;
an annotation data acquisition section for acquiring annotation data, which is linked with the web page data acquired by said web page data acquisition section, from an annotation server via said communication device;
a reflection section for converting contents of the annotation acquired by said annotation data acquisition section into a form that can be interpreted by said text-processing tool and for embedding the converted contents at a position to which the annotation should link; and
an output section for outputting the web page data to which the contents of the annotation are embedded by said reflection section to said text-processing tool.

5. The text data generation device according to claim 4, wherein said reflection section executes the converting and the embedding only for annotation data that satisfy a predetermined condition among the annotation data acquired by said annotation data acquisition section.

6. The text data generation device according to claim 5, wherein said reflection section chooses, when there are combinations of the annotation data in which character strings of linked destinations of the annotations on the web page are overlapped in part or as a whole among the annotation data acquired by said annotation data acquisition section,
the annotation data from the combinations by determining the annotation data whose range of the linked destination does not overlap with that of the other annotations, and wherein
said reflection section converts and embeds the contents of the annotation only for the chosen annotation data.

7. A text data generation method for generating text data as a processing target of a text-processing tool, said method being implemented by a computer that executes procedures comprising:
a reception procedure for receiving location information of web page data from the text-processing tool;
a web page data acquisition procedure for acquiring web page data from a web server via a communication device in response to the location information that is received by said reception procedure;
an annotation data acquisition procedure for acquiring annotation data, which is linked with the web page data acquired by said web page data acquisition procedure, from an annotation server via said communication device;
a reflection procedure for converting contents of the annotation acquired by said annotation data acquisition procedure into a form that can be interpreted by said text-processing tool and for embedding the converted contents at a position to which the annotation should link; and
an output procedure for outputting the web page data to which the contents of the annotation are embedded by said reflection procedure to said text-processing tool.

8. The text data generation method according to claim 7, wherein said reflection procedure executes the converting and the embedding only for annotation data that satisfy a predetermined condition among the annotation data acquired by said annotation data acquisition procedure.

9. The text data generation method according to claim 8, wherein said reflection procedure chooses, when there are combinations of the annotation data in which character strings of linked destinations of the annotations on the web page are overlapped in part or as a whole among the annotation data acquired by said annotation data acquisition procedure,
the annotation data from the combinations by determining the annotation data whose range of the linked destination does not overlap with that of the other annotations, and wherein
said reflection procedure converts and embeds the contents of the annotation only for the chosen annotation data.

10. A computer readable medium storing a text-processing tool program that controls a computer to execute functions comprising:
a web page data acquisition function for acquiring, when location information of a web page data is designated, the web page data from a web server via a communication device in response to the location information;
an annotation data acquisition function for acquiring annotation data, which is linked with the web page data acquired by said web page data acquisition function, from an annotation server via said communication device;
a reflection function for embedding contents of the annotation acquired by said annotation data acquisition function in a predetermined form at a position to which the annotation should link; and
a text-processing function for executing a text-processing based on the web page data into which the contents of the annotation are embedded by said reflection function.

11. The computer readable medium according to claim 10, wherein said reflection function executes the embedding only for annotation data that satisfy a predetermined condition among the annotation data acquired by said annotation data acquisition function.

12. The computer readable medium according to claim 11, wherein said reflection function chooses, when there are combinations of the annotation data in which character strings of linked destinations of the annotations on the web page are overlapped in part or as a whole among the annotation data acquired by said annotation data acquisition function, the annotation data from the combinations by determining the annotation data whose range of the linked destination does not overlap with that of the other annotations, and wherein said reflection function embeds the contents of the annotation only for the chosen annotation data.

13. A text-processing tool device comprising:
a web page data acquisition section for acquiring, when location information of a web page data is designated, the web page data from a web server via a communication device in response to the location information;
an annotation data acquisition section for acquiring annotation data, which is linked with the web page data acquired by said web page data acquisition section, from an annotation server via said communication device;
a reflection section for embedding contents of the annotation acquired by said annotation data acquisition section in a predetermined form at a position to which the annotation should link; and
a text-processing section for executing a text-processing based on the web page data into which the contents of the annotation are embedded by said reflection section.

14. The text-processing tool device according to claim 13, wherein said reflection section executes the embedding only for annotation data that satisfy a predetermined condition among the annotation data acquired by said annotation data acquisition section.

15. The text-processing tool device according to claim 14, wherein said reflection section chooses, when there are combinations of the annotation data in which character strings of linked destinations of the annotations on the web page are overlapped in part or as a whole among the annotation data acquired by said annotation data acquisition section, the annotation data from the combinations by determining the annotation data whose range of the linked destination does not overlap with that of the other annotations, and wherein said reflection section embeds the contents of the annotation only for the chosen annotation data.

16. A text-processing method that is implemented by a computer that executes procedures comprising:
a web page data acquisition procedure for acquiring, when location information of a web page data is designated, the web page data from a web server via a communication device in response to the location information;
an annotation data acquisition procedure for acquiring annotation data, which is linked with the web page data acquired by said web page data acquisition procedure, from an annotation server via said communication device;
a reflection procedure for embedding contents of the annotation acquired by said annotation data acquisition procedure in a predetermined form at a position to which the annotation should link; and
a text-processing procedure for executing a text-processing based on the web page data into which the contents of the annotation are embedded by said reflection procedure.

17. The text-processing method according to claim 16, wherein said reflection procedure executes the embedding only for annotation data that satisfy a predetermined condition among the annotation data acquired by said annotation data acquisition procedure.

18. The text-processing method according to claim 17, wherein said reflection procedure chooses, when there are combinations of the annotation data in which character strings of linked destinations of the annotations on the web page are overlapped in part or as a whole among the annotation data acquired by said annotation data acquisition procedure, the annotation data from the combinations by determining the annotation data whose range of the linked destination does not overlap with that of the other annotations, and wherein said reflection procedure embeds the contents of the annotation only for the chosen annotation data.
